(19) United States
(12) Patent Application Publication
(10) Pub. No.: US 2026/0104395 A1
(43) Pub. Date: Apr. 16, 2026

(54) ACOUSTIC SENSOR AND SUBSTRATE POLISHING DEVICE INCLUDING THE SAME

(71) Applicant: Samsung Electronics Co., Ltd., Suwon-si (KR)

(72) Inventor: DONGHOON KWON, Suwon-si (KR)

(21) Appl. No.: 19/185,408

(22) Filed: Apr. 22, 2025

(30) Foreign Application Priority Data
Oct. 14, 2024 (KR) 10-2024-0139841

(51) Int. Cl. G01N 29/24; B24B 37/013; G01N 29/14

(52) U.S. Cl. CPC G01N 29/2437; B24B 37/013; G01N 29/14

(57) ABSTRACT

Provided is an acoustic sensor including: a first electrode; a second electrode spaced apart from and facing the first electrode; a first seed layer disposed on an inner surface of the first electrode facing the second electrode; a second seed layer disposed on an inner surface of the second electrode facing the first electrode; and a plurality of nanorods disposed between the first seed layer and the second seed layer, wherein each nanorod among the plurality of nanorods includes a first nanorod portion in contact with the first seed layer, a second nanorod portion in contact with the second seed layer, and a coating disposed between the first nanorod portion and the second nanorod portion, wherein each nanorod includes two or more types of piezoelectric materials.

### CROSS-REFERENCE TO RELATED APPLICATION

This application claims priority to and the benefit of Korean Patent Application No. 10-2024-0139841 filed in the Korean Intellectual Property Office on Oct. 14, 2024, the entire contents of which are incorporated herein by reference.

### BACKGROUND OF THE INVENTION

### (a) Field of the Invention

The present disclosure relates to an acoustic sensor and a substrate polishing device including the same.

### (b) Description of the Related Art

A chemical mechanical polishing (CMP) process of a semiconductor may be a process of flattening a substrate surface by using a chemical reaction and a mechanical force. During the CMP process, a process referred to as over polishing for completely removing a metal layer may be required to minimize polishing non-uniformity occurring in a substrate.

However, the over polishing may result in worse dishing and erosion of a pattern, which has a significant impact on the reliability of a device. Therefore, an end point detection (EPD) device for monitoring a polishing completion time point may be used to minimize over polishing.

Typically, an EPD device that uses light disposed in a CMP facility may be used. However, signal noise may occur due to a medium such as an aqueous solution or air when using light.

A method of using a film quality feature of a substrate and an acoustic emission based having a unique value based on each process may be used to compensate for the above-mentioned disadvantage. This method may detect a sound wave, and monitor increase or decrease in the sound wave to thus determine a polishing endpoint, and measure a frictional change based on a film quality change by using the sound wave (vibration).

However, even when using the method of monitoring the increase and decrease in the sound wave, a signal attenuation may occur while the acoustic emission occurring in the substrate passes through a structure such as a polishing pad to thus reduce a signal to noise ratio (SNR) and fail to acquire sensitivity required to detect a heterogeneous film quality.

### SUMMARY OF THE INVENTION

The present disclosure provides an acoustic sensor capable of acquiring higher sensitivity than a conventional sensor. The acoustic sensor includes a plurality of nanorods with each including two or more types of piezoelectric materials. The present disclosure further provides a substrate polishing device including the acoustic sensor.

According to an embodiment, provided is an acoustic sensor including: a first electrode; a second electrode spaced apart from and facing the first electrode; a first seed layer disposed on an inner surface of the first electrode facing the second electrode; a second seed layer disposed on an inner surface of the second electrode facing the first electrode; and a plurality of nanorods disposed between the first seed layer and the second seed layer, wherein each nanorod among the plurality of nanorods includes a first nanorod portion in contact with the first seed layer, a second nanorod portion in contact with the second seed layer, and a coating connecting the first nanorod portion and the second nanorod portion with each other, wherein each nanorod includes two or more types of piezoelectric materials.

According to an embodiment, provided is an acoustic sensor including: a first electrode; a second electrode spaced apart from and facing the first electrode; a seed layer including a first piezoelectric material disposed on an inner surface of the first electrode facing the second electrode; a plurality of nanorods, each including the first piezoelectric material and extending from the seed layer toward the second electrode; and a coating on each of the plurality of nanorods, the coating including a second piezoelectric material and disposed on at least a portion of each of the plurality of nanorods and the seed layer.

According to an embodiment, provided is a substrate polishing device including: a platen; a polishing pad disposed on an upper surface of the platen and rotated together with the platen; a head supporting a substrate for a polishing surface of the substrate to face the polishing pad; and an acoustic sensor embedded in the polishing pad, wherein the acoustic sensor includes a plurality of nanorods with each nanorod including two or more types of piezoelectric materials.

According to the embodiments, the acoustic sensor which includes the plurality of nanorods with each nanorod including the two or more types of piezoelectric materials may increase the signal sensitivity of the acoustic sensor for identifying a change in the film quality using a sound wave generated by friction in a polishing process.

### BRIEF DESCRIPTION OF THE DRAWINGS

FIG. 1 is a view showing an acoustic sensor according to an embodiment.

FIGS. 2A to 2C are views showing a process of manufacturing the acoustic sensor shown in FIG. 1.

FIGS. 3A to 3E are views showing various shapes of a nanorod in the acoustic sensor according to an embodiment.

FIGS. 4A and 4B are views showing an acoustic sensor according to an embodiment different from that shown in FIG. 1.

FIG. 5 is a view showing an acoustic sensor according to another embodiment.

FIGS. 6A and 6B are views showing a process of manufacturing the acoustic sensor shown in FIG. 5.

FIGS. 7A and 7B are views each showing an acoustic sensor according to another embodiment.

FIGS. 8A and 8B are views showing a process of manufacturing the acoustic sensor shown in FIGS. 7A and 7B.

FIG. 9 is a view showing an acoustic sensor according to another embodiment.

FIGS. 10A and 10B are views showing a process of manufacturing the acoustic sensor shown in FIG. 9.

FIGS. 11A and 11B are views each showing an acoustic sensor according to another embodiment.

FIGS. 12A and 12B are views showing a process of manufacturing the acoustic sensor shown in FIGS. 11A and 11B.

FIGS. 13A and 13B are views each showing an acoustic sensor according to another embodiment.

FIGS. 14A and 14B are views showing a process of manufacturing the acoustic sensor shown in FIGS. 13A and 13B.

FIG. 15 is a view showing a substrate polishing device according to an embodiment.

FIG. 16 is a view showing the substrate polishing device from the top according to an embodiment.

FIGS. 17 to 20 are views showing various embodiments of the acoustic sensor disposed in the substrate polishing device.

### DETAILED DESCRIPTION OF THE EMBODIMENTS

Hereinafter, embodiments of the present disclosure are described in detail with reference to the accompanying drawings so that those skilled in the art to which the present disclosure pertains may practice the inventive concept. The present disclosure may be implemented in various different forms and should not be construed as limited to the embodiments provided herein. It should also be emphasized that the disclosure provides details of alternative examples, but such listing of alternatives is not exhaustive. Furthermore, any consistency of detail between various examples should not be interpreted as requiring such detail. The language of the claims should be referenced in determining the requirements of the invention.

Details that may be unrelated to the inventive concept may be omitted in order to clearly describe the present disclosure, and the same or similar components are denoted by the same reference numeral throughout the specification.

In addition, the size and thickness of each component shown in the accompanying drawings are arbitrarily shown for convenience of description, and therefore, the present disclosure is not necessarily limited to contents shown in the drawings. The thicknesses are exaggerated in the drawings in order to clearly represent several layers and regions. In addition, the thicknesses of some layers and regions may be exaggerated in the drawings for convenience of description.

Throughout the present specification, when any one part is referred to as being “connected” or “coupled” to or “on” another part, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

Throughout the specification, when a component is described as “including” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

In addition, when an element such as a layer, a film, a region, or a plate is referred to as being “on” or “above” another element, the element may be “directly on” another element or may have a third element interposed therebetween. On the other hand, when an element is referred to as being “directly on” another element, there is no third element interposed therebetween. In addition, when an element is referred to as being “on” or “above” a reference element, the element may be disposed on or below the reference element, and may not necessarily be “on” or “above” the reference element in an opposite direction of gravity.

In addition, throughout the specification, an expression “on a plane” may indicate a case where a target is viewed from the top, and an expression “on a cross-section” may indicate a case where a cross-section of the target taken along a vertical direction is viewed from its side.

An acoustic emission during polishing of a substrate may indicate a film quality feature of the substrate. The acoustic emission having a unique value based on each process and monitoring increases and decreases in the acoustic emission and/or changes in the frequency response may be used to determine a polishing endpoint.

When using the above-mentioned method, signal strength attenuation may occur when the acoustic emission generated by polishing a substrate passes through a polishing pad made of porous polyurethane and a region in which the transmission medium is air. For example, signal attenuation may occur when an acoustic signal passes through the polishing pad and the air medium, and the signal attenuation may reduce a signal to noise ratio (SNR) of the signal. As a result, measurement of acoustic emissions may fail to achieve the sensitivity required to detect a heterogeneous film quality.

An acoustic sensor 400 and a substrate polishing device 10 including the same according to the present disclosure may overcome the problems identified above and may increase the signal sensitivity.

Hereinafter, the acoustic sensor and the substrate polishing device including the same according to embodiments of the present disclosure are described in more detail with reference to the drawings.

The substrate polishing device according to the present disclosure may be a device that includes an acoustic sensor that detects the acoustic emission generated in a substrate being polished by the substrate polishing device and uses the increase or decrease in the acoustic emission to thus determine the polishing endpoint.

An acoustic emission (AE) is the radiation of acoustic energy in the form of an elastic wave generated when a material rapidly releases accumulated elastic energy when the material is deformed plastically. For example, an acoustic emission (AE) may be energy that is released when a material or structure is cracked by an external force and the energy may be released as an ultrasonic sound wave within a frequency of 50 kHz to 10 MHz.

An acoustic sensor and a substrate polishing device including the same according to the present disclosure may determine the polishing endpoint of a substrate by determining a film quality feature of a polishing layer of the substrate using an acoustic emission, detect a change in the film quality feature of the substrate using a sound wave or vibration generated in a polishing surface of the substrate during a polishing process, and use this information to determine an end of the polishing process.

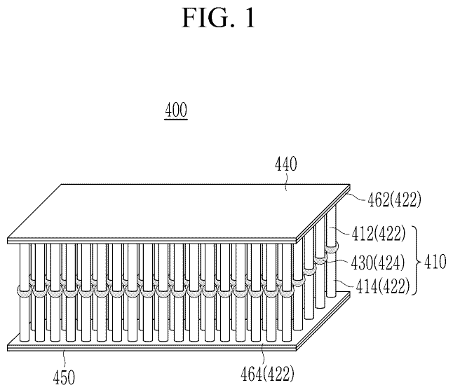

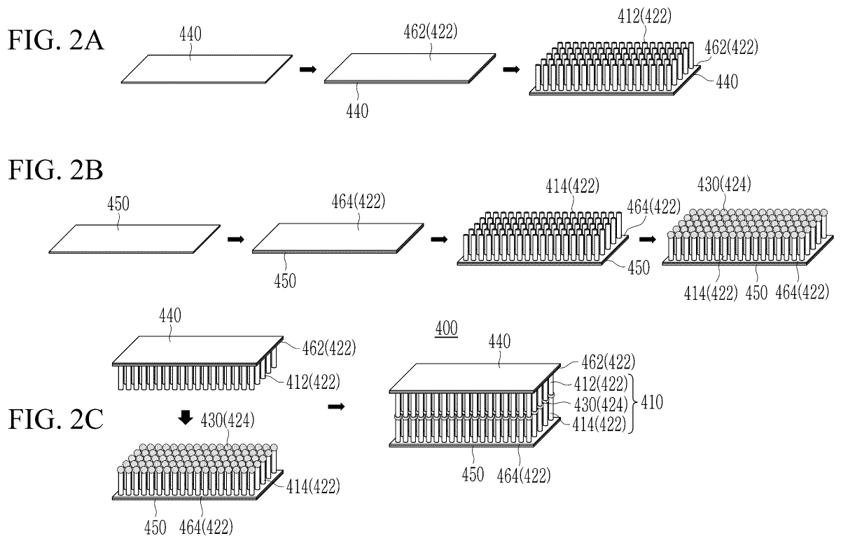

FIG. 1 is a view showing the acoustic sensor according to an embodiment, and FIGS. 2A to 2C are views showing a process of manufacturing the acoustic sensor shown in FIG. 1.

As shown in FIG. 1, the acoustic sensor 400 according to the present disclosure may include a first electrode 440, a second electrode 450 spaced apart from and facing the first electrode 440, a first seed layer 462 disposed on an inner surface of the first electrode 440 among the inner surfaces of the first electrode 440 and the second electrode 450 facing each other, a second seed layer 464 disposed on the inner surface of the second electrode 450, and a plurality of nanorods 410 extending from the first seed layer 462 toward the second seed layer 464.

The first electrode 440 and the second electrode 450 may each be formed from and/or include a conductive metal or a conductive polymer.

In each nanorod 410 among the plurality of nanorods 410, a first nanorod portion 412 and a second nanorod portion 414 may be connected to each other. Each nanorod 410 may include the first nanorod portion 412, the second nanorod portion 414, and a coating 430.

Each nanorod 410 may include the first nanorod portion 412, which has a first end in contact with the first seed layer 462 and a second end opposite the first end extending toward the second electrode 450, the second nanorod portion 414 having one end in contact with the other end of the first nanorod portion 412 and the other end in contact with the second seed layer 464, and the coating 430 disposed in a portion where the first nanorod portion 412 and the second nanorod portion 414 are in contact with each other.

Each nanorod 410 may include two or more types of piezoelectric materials 420 (e.g., first piezoelectric material 422 and second piezoelectric material 424).

For example, each of the first nanorod portion 412, the second nanorod portion 414, and the coating 430, which are included in each nanorod 410, may include at least two types of piezoelectric materials 420. In the drawings and their descriptions, the two or more types of piezoelectric materials 420 are described as including, for example, the first piezoelectric material 422, the second piezoelectric material 424, and a third piezoelectric material 426. The respective piezoelectric materials 420 are different from each other.

FIG. 1 shows an embodiment using two types of piezoelectric materials 420 (e.g., first piezoelectric material 422 and second piezoelectric material 424).

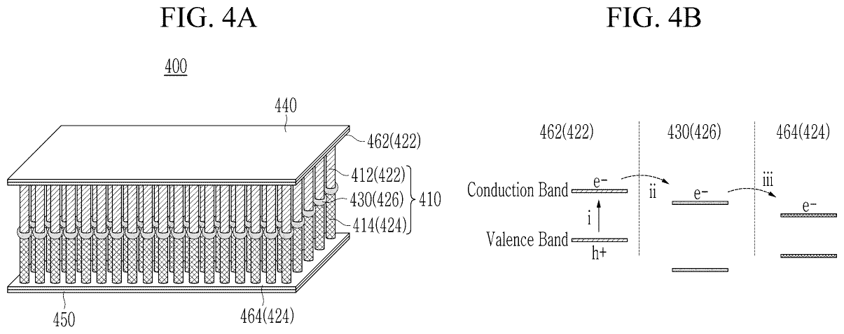

FIGS. 4A and 4B show an embodiment using three types of piezoelectric materials 420 (e.g., first piezoelectric material 422, second piezoelectric material 424, and third piezoelectric material 426), which is a different configuration than that shown in FIG. 1.

The piezoelectric material 420 may be a piezoelectric material such as barium titanate (BaTiO₃), zinc oxide (ZnO), or tungsten trioxide (WO₃), or the like.

Referring to FIG. 1, the first nanorod portion 412 and the second nanorod portion 414 may include the first piezoelectric material 422, and the coating 430 may include the second piezoelectric material 424.

The acoustic sensor 400 according to the present disclosure may have an increased sensitivity frequency range through the use of the plurality of nanorods 410 each including the two or more types of piezoelectric materials 420.

If an acoustic sensor were to use a nanorod with a single piezoelectric material, the acoustic sensor may have a limited sensitivity frequency range and thus may if may be difficult to detect a time point at which a film quality of a substrate is changed.

For example, a frequency of the corresponding acoustic emission may change based on the film quality of substrate 1 and having limited sensitivity frequency range may result in not detecting acoustic emissions at different film qualities.

Accordingly, the acoustic sensor 400 in the present disclosure may have a detectable frequency range expanded by increasing the sensitivity frequency range by using the two or more types of piezoelectric materials 420. As a result, in a process of polishing the film quality of the substrate 1, the acoustic sensor 400 may more accurately detect the time point at which the film quality of the substrate 1 is changed.

The first seed layer 462 may function to connect the plurality of first nanorod portions 412 with the first electrode 440, and the second seed layer 464 may function to connect the plurality of second nanorod portions 414 with the second electrode 450.

The first seed layer 462 may include the first piezoelectric material 422 included in each of the plurality of first nanorod portions 412, and the second seed layer 464 may include the first piezoelectric material 422 included in each of the plurality of second nanorod portions 414.

FIG. 1 shows that the coating 430 is disposed at the portion where the first nanorod portion 412 and the second nanorod portion 414 are connected with each other (e.g., the coating 430 may connect the first nanorod portion 412 and the second nanorod portion 414). As shown in the drawing, the second piezoelectric material 424 included in the coating 430 may have a particle shape (e.g., a ball shape).

According to an embodiment shown in FIG. 1, the acoustic sensor 400 may include the first electrode 440, the first seed layer 462, the plurality of nanorods 410, the second seed layer 464, and the second electrode 450, which are sequentially disposed from the top with each of the plurality of nanorods including the first nanorod portion 412, the coating 430, and the second nanorod portion 414.

In this embodiment, the first seed layer 462 and the second seed layer 464 may include the same first piezoelectric material 422. For example, the entirety of the first seed layer 462, the first nanorod portion 412, the second nanorod portion 414, and the second seed layer 464 may include the first piezoelectric material 422, and only the coating 430 disposed between the nanorod portions may include the second piezoelectric material 424.

Although not shown in the drawing, the acoustic sensor 400 may further include a signal amplifier film.

The signal amplifier film may be disposed between the first electrode 440 and the plurality of nanorods 410 and function to increase a contact area between the first electrode 440 and the plurality of nanorods 410. The signal amplifier film may be disposed at one end of each of the plurality of nanorods 410.

The signal amplifier film may include the same conductive polymer material as the first electrode 440 and function to amplify an electrical signal generated from each of the plurality of nanorods 410. In this way, it is possible to amplify the sound wave or the electrical signal, generated by vibration in the polishing process.

In an embodiment, the signal amplifier film may include a conductive polymer material (e.g., gold (Au)/platinum (Pt) coated polyether sulfone (PES)). Polyether sulfone (PES) is a resin having a high heat resistance.

Referring to FIGS. 2A to 2C, the manufacturing process of the acoustic sensor 400 shown in FIG. 1 will be described.

FIG. 2A shows a manufacturing process of the first electrode 440, the first seed layer 462, and the plurality of first nanorod portions 412. First, the first electrode 440 may be obtained, and the first seed layer 462 may be deposited on the first electrode 440. In this embodiment, the first seed layer 462 may include the first piezoelectric material 422. After depositing the first seed layer 462, the plurality of first nanorod portions 412 each including the first piezoelectric material 422 may be grown on the first seed layer 462. The plurality of first nanorod portions 412 may be formed on the first seed layer 462 by reacting the first seed layer 462 with a specific aqueous solution that includes the first piezoelectric material 422. The specific aqueous solution is an aqueous solution capable of growing the plurality of first nanorod portions 412 each including the first piezoelectric material 422 (e.g., an aqueous solution including the first piezoelectric material).

FIG. 2B shows a manufacturing process of the second electrode 450, the second seed layer 464, and the plurality of second nanorod portions 414. First, the second electrode 450 may be obtained, and the second seed layer 464 may be deposited on the second electrode 450. In this embodiment, the second seed layer 464 may include the first piezoelectric material 422. After depositing the second seed layer 464, the plurality of second nanorod portions 414 each including the first piezoelectric material 422 may be grown on the second seed layer 464. The plurality of second nanorod portions 414 may be formed on the second seed layer 464 by reacting the second seed layer 464 with a specific aqueous solution. The process up to this point may be the same as that shown in FIG. 2A.

However, the process in FIG. 2B may include an additional process of forming the coating 430 at the portion where the first nanorod portion 412 and the second nanorod portion 414 will be in contact with each other. The coating 430 including the particle-shaped second piezoelectric material 424 may be applied on top of each of the plurality of second nanorod portions 414 formed on the second seed layer 464 (e.g., formed at the end of a second nanorod portion 414 opposite the second seed layer).

FIG. 2C shows a process of coupling structures respectively manufactured in the processes shown in FIGS. 2A and 2B to each other. The structure manufactured in the process shown in FIG. 2A may be flipped over to dispose the first electrode 440 to be on the top, and then the structure may be coupled to the structure manufactured in the process shown in FIG. 2B.

Accordingly, each nanorod 410 among the plurality of nanorods 410 may include the first nanorod portion 412, the coating 430, and the second nanorod portion 414.

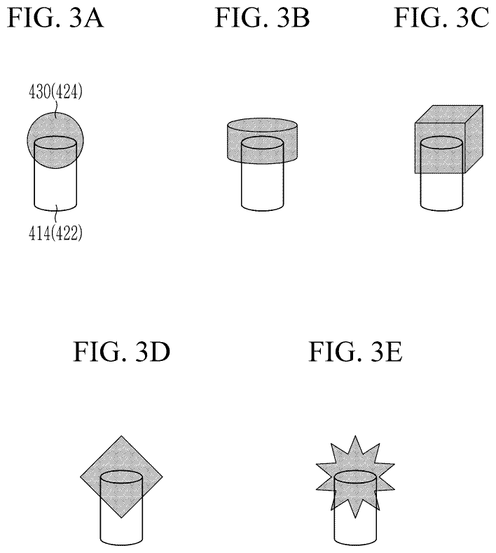

FIGS. 3A to 3E are views showing various shapes of the nanorod including the coating 430 in the acoustic sensor according to an embodiment.

FIGS. 3A to 3E show the second nanorod portion 414 and the coating 430 disposed on the second nanorod portion 414 among the plurality of nanorods 410 shown in FIG. 1.

As shown in FIGS. 3A to 3E, the second piezoelectric material 424 included in the coating 430 may have the particle shape. The particle shape may be a spherical, cylindrical, rectangular, rhombic, or another polygonal shape as shown in FIGS. 3A to 3E.

An embodiment using the spherical shape (in FIG. 3A) may maximize the contact area and a surface area and may be preferable when considering the contact area between each nanorod 410 and the respective coating 430, and the surface area of the coating 430 itself.

FIGS. 4A and 4B are views showing an acoustic sensor according to another embodiment that is different from that shown in FIG. 1.

Referring to FIG. 4A, the first nanorod portion 412 may include the first piezoelectric material 422, the second nanorod portion 414 may include the second piezoelectric material 424, and the coating 430 may include the third piezoelectric material 426.

The acoustic sensor shown in FIG. 4A may be manufactured through the same process as that shown in FIGS. 2A to 2C. However, in the acoustic sensor of FIG. 4A the first nanorod portion 412 and the second nanorod portion 414 each include different piezoelectric materials 420 from each other.

In FIG. 4A, the first seed layer 462 may include the first piezoelectric material 422 included in each of the first nanorod portions 412, and the second seed layer 464 may include the second piezoelectric material 424 included in each of the plurality of second nanorod portions 414.

Unlike FIG. 1, in FIG. 4A, the first seed layer 462 and the first nanorod portion 412 may include the first piezoelectric material 422, the second nanorod portion 414 and the second seed layer 464 may include the second piezoelectric material 424, and the coating 430 may include the third piezoelectric material 426. For example, each nanorod 410 may include the three different types of piezoelectric materials 420.

FIG. 4B shows a signal enhancing effect, which is an effect of using the acoustic sensor 400 shown in FIG. 4A.

FIG. 4B shows the energy levels of the conduction band, valence band, and the resulting energy barrier (e.g., band gap) for each of, from the left, the first piezoelectric material 422 forming the first seed layer 462 and the first nanorod portions 412, the coating 430 including the third piezoelectric material 426, and the second piezoelectric material 424 forming the second seed layer 464 and the second nanorod portion 414.

In FIG. 4B, i represents the energy levels of the conduction band and the valence band of the first piezoelectric material, which forms the first seed layer 462 and the first nanorod portion 412. and shows a vibrational energy that is transmitted to the first seed layer 462 to form active electrons e− in the conduction band.

A movement of electrons e− indicated by ii represents the electron movement from the first piezoelectric material 422, which includes the first seed layer 462 and the first nanorod portion 412, to the coating 430, which includes the third piezoelectric material 426. For a positive hole h+, an energy barrier may be higher in the third piezoelectric material 426 than the third piezoelectric material 422. The movement represented by ii indicates that the electrons e− move to the third piezoelectric material 426, which has a lower conduction band level while having a larger band gap (e.g., a larger difference between a valence band and a conduction band).

The movement of the electrons e−, indicated by iii, represents the electron movement from the coating 430 including the third piezoelectric material 426 to the second piezo electric material 424 forming the second seed layer 464 and the second nanorod portion 414. This movement indicates that the electrons e− move to the second piezoelectric material 424, which has the lowest conduction band level.

As a result, the acoustic sensor 400 according to the present disclosure may use the two or more types of piezoelectric materials 420 to thus prevent the electron e− and hole h+ pairs from being annihilated while the electrons e− move to each of the piezoelectric materials 420, thereby enhancing the signal (e.g., the band gap between the conduction band in i and the valence band in iii is greater than the band gap between the conduction band and the valence band in i).

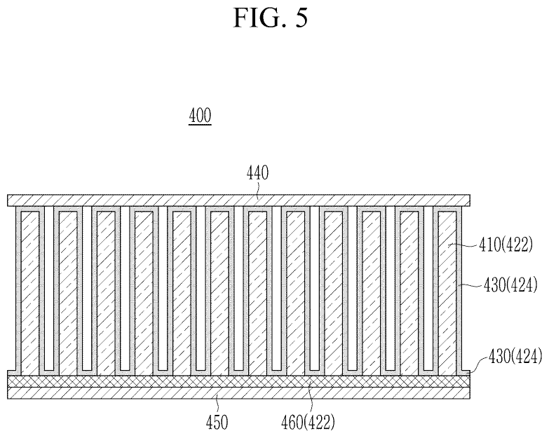

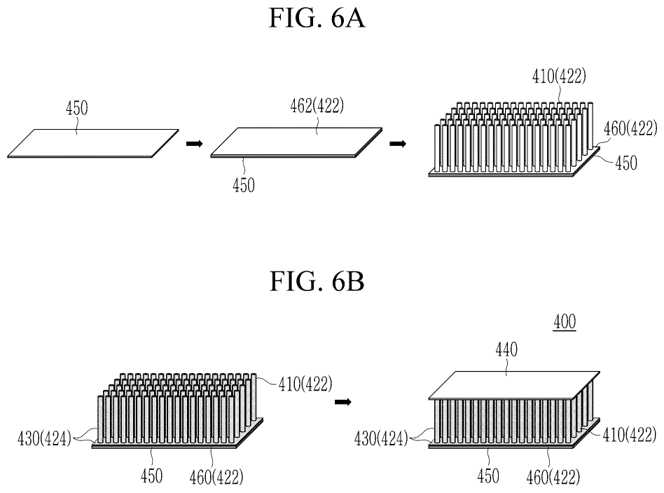

FIG. 5 is a view showing an acoustic sensor according to another embodiment, and FIGS. 6A and 6B are views showing a process of manufacturing the acoustic sensor shown in FIG. 5.

FIG. 5 shows a cross-section of an acoustic sensor 400 to describe the coating 430.

As shown in FIG. 5, the acoustic sensor 400 according to the present disclosure may include a first electrode 440, a second electrode 450 spaced apart from and facing the first electrode 440, a seed layer 460 including the first piezoelectric material 422 and disposed on one of the inner surfaces of the first electrode 440 and the second electrode 450 facing each other, the plurality of nanorods 410 each including the first piezoelectric material 422, and a coating 430 including the second piezoelectric material 424. The coating 430 is disposed on at least a portion of each of the plurality of nanorods 410 and the seed layer 460.

Each of the plurality of nanorods 410 may extend from the seed layer 460 toward whichever one of the first electrode 440 or the second electrode 450 is spaced apart from the seed layer 460. Each of the plurality of nanorods 410 may have a rod shape and have a first end in contact with the seed layer 460 and a second end in contact with whichever of the first electrode 440 or the second electrode 450 is spaced apart from the seed layer 460.

FIG. 5 shows an embodiment in which the seed layer 460 is in contact with the second electrode 450 and each of the plurality of nanorods 410 extends from the seed layer 460 toward the first electrode 440.

As shown in FIG. 5, the coating 430 including the second piezoelectric material 424 may form a layer on a surface of the seed layer 460 and the entire exposed surface of each of the plurality of nanorods 410.

Referring to FIGS. 6A and 6B, the description examines the manufacturing process of the acoustic sensor 400 shown in FIG. 5.

FIG. 6A shows a manufacturing process of the second electrode 450, the seed layer 460, and the plurality of nanorods 410.

First, the second electrode 450 may be obtained and the seed layer 460 may be deposited on the second electrode 450. In this embodiment, the seed layer 460 may include the first piezoelectric material 422. After depositing the seed layer 460, the plurality of nanorods 410 each including the first piezoelectric material 422 may be grown on the seed layer 460. The plurality of nanorods 410 may be formed on the seed layer 460 by reacting the seed layer 460 with a specific aqueous solution. The specific aqueous solution is an aqueous solution capable of growing the first piezoelectric material 422 from the seed layer 460 to become the plurality of nanorods 410.

The process in FIG. 6B includes a process of applying the second piezoelectric material 424 to a structure manufactured in the process in FIG. 6A form the coating 430.

The second piezoelectric material 424 may be applied to form a layer on a surface of each target to form the coating 430. For example, referring to FIG. 6B, the coating 430 may be formed in a layer on the surfaces of the seed layer 460 and the plurality of nanorods 410.

Accordingly, the second piezoelectric material 424 may have a different shape from that of the particle-shaped second piezoelectric material 424 included in the coating 430 shown in FIGS. 1, 4A, and 4B.

As shown in FIG. 6B, a region to which the coating 430 is being applied may react with a specific aqueous solution including the second piezoelectric material 424 in order to apply the coating 430 to the entire exposed surfaces of the seed layer 460 and the plurality of nanorods 410.

The first electrode 440 may be coupled to the top of the plurality of nanorods 410 after the coating 430 is applied to the entire exposed surfaces of the seed layer 460 and the plurality of nanorods 410.

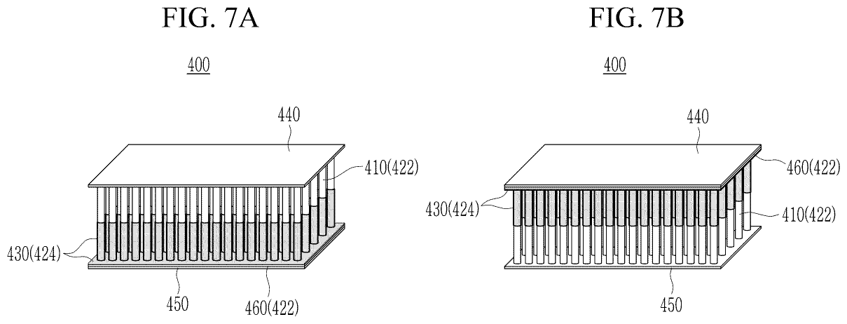

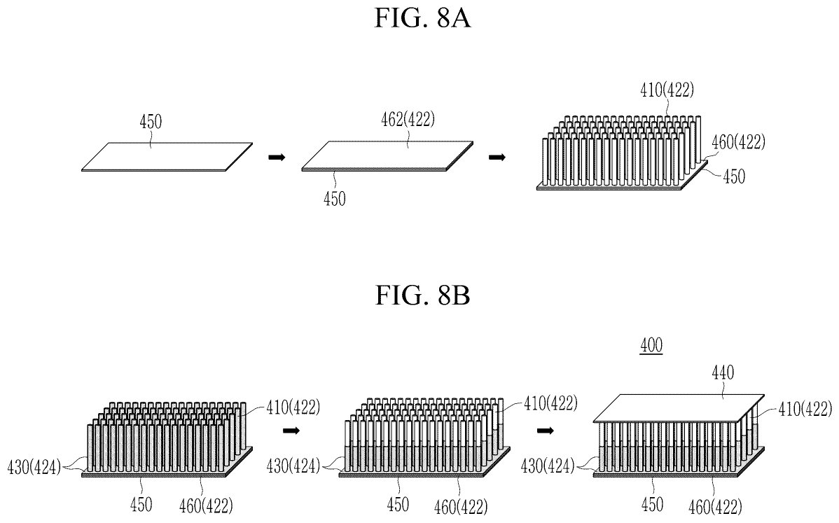

FIGS. 7A and 7B are each views showing an acoustic sensor according to another embodiment, and FIGS. 8A and 8B are views showing a process of manufacturing the acoustic sensor shown in FIGS. 7A and 7B.

As shown in FIGS. 7A and 7B, the second piezoelectric material 424 may be applied for to form the coating 430 as a layer on at least a portion of each surface of the seed layer 460 and the plurality of nanorods 410, including an end of each of the plurality of nanorods 410 that is in contact with the seed layer 460.

In FIG. 7A, the seed layer 460 may be formed on a lower electrode and the coating 430 may be formed on the surface of the seed layer 460 that is disposed on the bottom electrode. In addition, the coating 430 may be applied to about half of a lower portion of each of the plurality of nanorods 410, including the end (the bottom) of each of the plurality of nanorods 410 that is in contact with the seed layer 460.

In FIG. 7B, the seed layer 460 may be formed on the top electrode and the coating 430 may be formed on the surface of the seed layer 460 that is disposed on the top electrode. In addition, the coating 430 may be applied to about half of an upper portion of each of the plurality of nanorods 410, including the end (the top) of each of the plurality of nanorods 410 that is in contact with the seed layer 460.

FIGS. 8A and 8B are views showing a process of manufacturing the acoustic sensor 400 shown in FIG. 7A. A structure shown in FIG. 7B may be manufactured in the same way as that shown in FIG. 7A and then reorientated by rotating the structure upside down.

FIG. 8A shows a manufacturing process of the second electrode 450, the seed layer 460, and the plurality of nanorods 410. This process may be the same as that shown in FIG. 6A.

The process shown in FIG. 8B includes a process of applying the second piezoelectric material 424 to a structure manufactured in the process shown in FIG. 8A to form the coating 430.

As shown in FIG. 8B, a region to which the second piezoelectric material is applied may be made to react with the specific aqueous solution including the second piezoelectric material 424 in order to form the coating 430 to the entire surfaces of the seed layer 460 and the plurality of nanorods 410.

To form the embodiment shown in FIG. 7A, the coating 430 may be formed on only about half of each of the plurality of nanorods 410, including its lower portion, unlike FIG. 5, which shows the coating 430 applied to the entire surfaces of the plurality of nanorods 410.

Accordingly, a process of removing the portion of the second piezoelectric material 424 applied to a surface of the upper portion of each of the plurality of nanorods 410 may be required. To this end, an etching process may be performed on the upper portion of each of the plurality of nanorods 410 to remove the coating 430.

The first electrode 440 may be coupled to the upper portion of each of the plurality of nanorods 410 after removing the coating 430 applied to the upper portion.

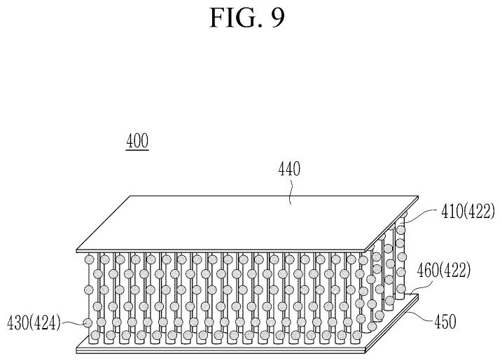

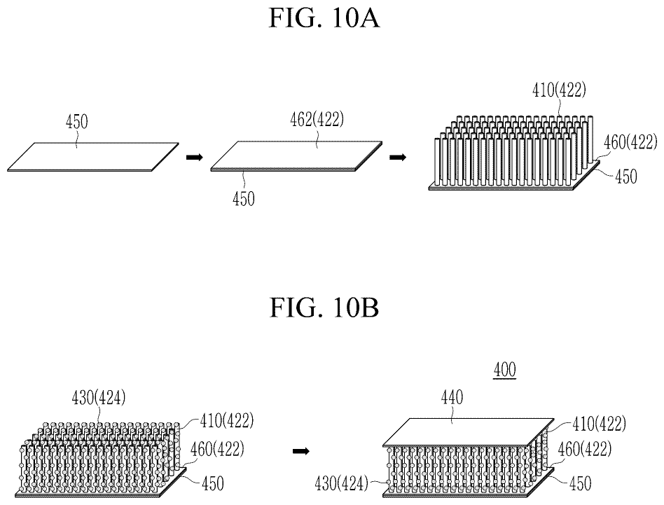

FIG. 9 is a view showing an acoustic sensor according to another embodiment, and FIGS. 10A and 10B are views showing a process of manufacturing the acoustic sensor shown in FIG. 9.

Referring to FIG. 9, the coating 430 may have a particle shape.

FIGS. 5, 7A, and 7B show an embodiment in which the second piezoelectric material 424 of the coating 430 is applied to form a layer on the surface of each target. In this respect, the particle-shaped second piezoelectric material 424 of the coating 430 shown in FIG. 9 has a different shape from that shown in FIGS. 5, 7A, and 7B.

For reference, the coating 430 shown in FIG. 9 has a similar shape to that of the particle-shaped second piezoelectric material 424 included in the coating 430 shown in FIGS. 1, 4A, and 4B.

According to an embodiment, the particle-shaped second piezoelectric material 424 included in the coating 430 may be applied to the entire surfaces of the plurality of nanorods 410 formed on the seed layer 460.

Referring to FIGS. 10A and 10B, the description examines the manufacturing process of the acoustic sensor 400 shown in FIG. 9.

FIG. 10A shows a manufacturing process of the second electrode 450, the seed layer 460, and the plurality of nanorods 410. This process may be the same as that shown in FIG. 6A.

The process shown in FIG. 10B includes a process of applying the coating 430 including the second piezoelectric material 424 to a structure manufactured in the process shown in FIG. 10A.

As shown in FIG. 10B, a region to which the coating 430 is applied may be made to react with the specific aqueous solution including the second piezoelectric material 424 in order to form the coating 430 to the entire surfaces of the plurality of nanorods 410.

FIGS. 5, 7A, and 7B show that the coating 430 has a layer shape, and the coating 430 is applied also to the surface of the seed layer 460 in the process of applying the coating 430 to the plurality of nanorods.

On the other hand, FIG. 9 shows the particle-shaped coating 430. Accordingly, the coating 430 may be applied only to the plurality of nanorods 410 in the process of applying the coating 430 to the plurality of nanorods 410. For example, the particle-shaped coating 430 may not be applied to the surface of the seed layer 460.

The first electrode 440 may be coupled to the upper portion of each of the plurality of nanorods 410 after the coating 430 is applied to the entire surfaces of the plurality of nanorods 410.

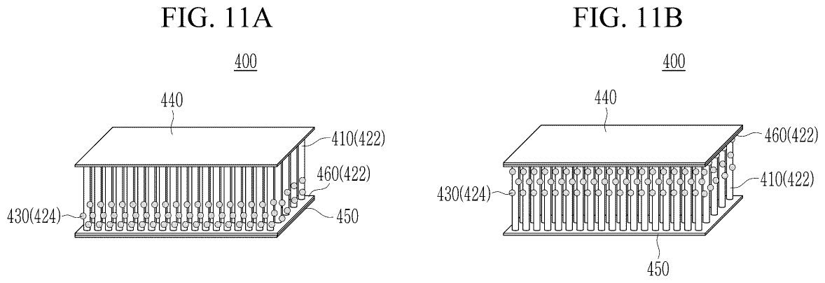

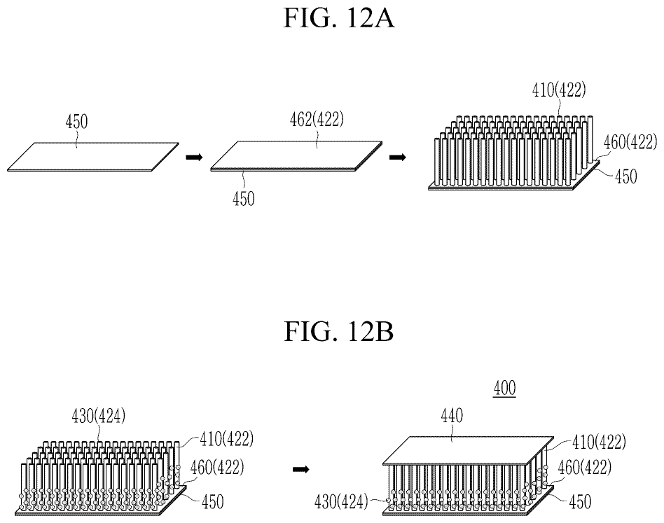

FIGS. 11A and 11B are views showing an acoustic sensor according to another embodiment, and FIGS. 12A and 12B are views showing a process of manufacturing the acoustic sensor shown in FIGS. 11A and 11B.

FIGS. 11A and 11B show an embodiment in which the particle-shaped second piezoelectric material 424 included in the coating 430 is applied to at least a portion of the surface of each of the plurality of nanorods, including whichever end of each of the plurality of nanorods is in contact with the seed layer 460.

In FIG. 11A, the seed layer 460 may be disposed at the bottom to be in contact with the second electrode 450. Accordingly, the coating 430 may be applied to a surface of about half of the lower portion of each nanorod 410, including the other end (the bottom) of each of the plurality of nanorods 410 that is in contact with the seed layer 460.

In FIG. 11B, the seed layer 460 may be disposed to be in contact with the first electrode 440 which is on top. Accordingly, the coating 430 may be formed on a surface of about half of the upper portion of each nanorod 410, including one end (the top) of each of the plurality of nanorods 410 that is in contact with the seed layer 460. It may be seen that the structure shown in FIG. 11B is provided by rotating the structure shown in FIG. 11A upside down and the primary difference may be that the first electrode 440 and the second electrode 450 are arranged to have different positions.

FIGS. 12A and 12B are views showing a process of manufacturing the acoustic sensor 400 shown in FIG. 11A.

FIG. 12A shows a manufacturing process of the second electrode 450, the seed layer 460, and the plurality of nanorods 410. This process may be the same as that shown in FIG. 6A.

The process shown in FIG. 12B includes a process of applying the particle-shaped second piezoelectric material 424 to a structure manufactured in the process shown in FIG. 12A to form the coating 430. Unlike the embodiment of FIG. 9, FIGS. 11A and 11B show an embodiment in which the coating 430 is applied only to the lower portion of each of the plurality of nanorods 410.

First, a region to which the coating 430 is to be applied may be made to react with the specific aqueous solution including the second piezoelectric material 424 in order to apply the second piezoelectric material 424 and form the coating 430 on the entire surfaces of the plurality of nanorods 410. Next, the etching process may be performed on the upper portion of each of the plurality of nanorods 410 to remove the second piezo electric material 424 that does not form the coating 430.

The drawing omits a process of removing the coating 430 applied to the upper portion through etching after applying the coating 430 to all of the plurality of nanorods 410 (see FIG. 8B).

The first electrode 440 may be coupled to the upper portion of each of the plurality of nanorods 410 after removing the second piezoelectric material applied to the upper portion of the plurality of nanorods 410.

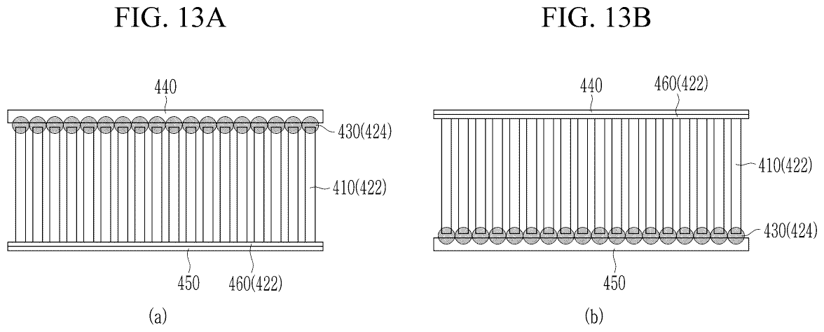

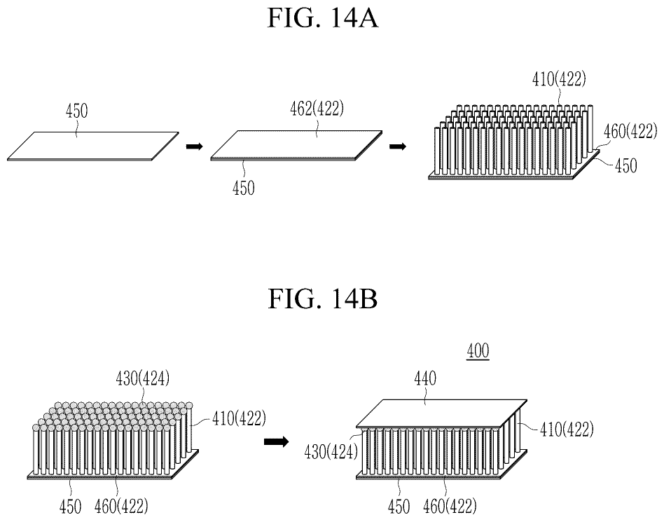

FIGS. 13A and 13B are views showing an acoustic sensor according to another embodiment, and FIGS. 14A and 14B are views showing a process of manufacturing the acoustic sensor shown in FIGS. 13A and 13B. FIGS. 13A and 13B show a cross-section of the acoustic sensor 400 to describe the coating 430.

FIGS. 13A and 13B show an embodiment in which the particle-shaped second piezoelectric material 424 included in the coating 430 is applied only to whichever end of each of the plurality of nanorods 410 is in contact with either the first electrode 440 or the second electrode 450 and which is spaced apart from the seed layer 460.

In FIG. 13A, the coating 430 may be disposed on an end (the top) of each of the plurality of nanorods that will be in contact with the first electrode 440, which is spaced apart from the seed layer 460 disposed at the bottom.

In FIG. 13B, the coating 430 may be disposed on an end (the bottom) of each of the plurality of nanorods that will be in contact with the second electrode 450, which is spaced apart from the seed layer 460 disposed on the top. It may be seen that a structure shown in FIG. 13B is provided by rotating that shown in FIG. 13A upside down, and the primary difference is only that the first electrode 440 and the second electrode 450 are arranged to have different positions.

FIGS. 14A and 14B are views showing a process of manufacturing the acoustic sensor 400 shown in FIG. 13A. This process may be the same as that shown in FIG. 6A.

The process shown in FIG. 14B includes a process of applying the coating 430 including the particle-shaped second piezoelectric material 424 to the structure manufactured in the process shown in FIG. 13A. The coating 430 may be disposed on an end (the top) of each of the plurality of nanorods 410 that will be in contact with the first electrode 440.

The acoustic sensor 400 may be completely manufactured by coupling the first electrode 440 to the top of the applied coating 430.

In the acoustic sensor 400 according to the present disclosure, the two or more types of piezoelectric materials 420 may be included in nanorod 410, as described with reference to FIGS. 1 through 14B. Through this configuration, the signal may be enhanced by preventing the annihilation of the electron e− and hole h+ pairs while the electrons e− are moved between each piezoelectric material 420.

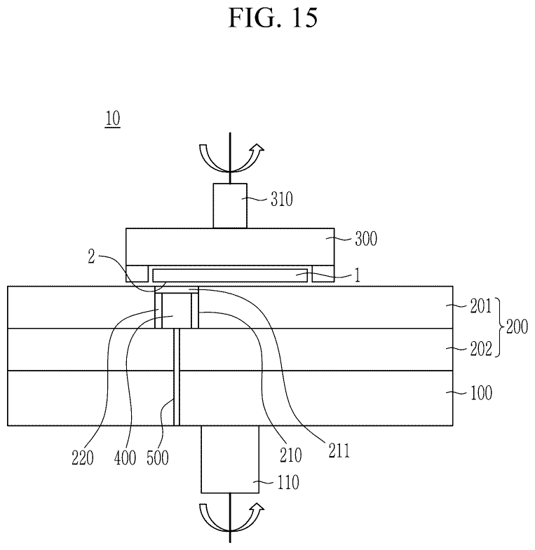

FIG. 15 is a view showing the substrate polishing device according to an embodiment.

As shown in FIG. 15, the substrate polishing device 10 according to the present disclosure may include a platen 100, a polishing pad 200 disposed on an upper surface of the platen 100 and rotated together with the platen 100, a head 300 supporting a substrate 1 for a polishing surface 2 of the substrate 1 to face the polishing pad 200, and an acoustic sensor 400 embedded in the polishing pad 200, wherein the acoustic sensor 400 includes a plurality of nanorods 410 each including two or more types of piezoelectric materials 420 (see FIGS. 1 through 14B for the structure of the acoustic sensor 400).

The polishing pad 200 may include a hole 210 having an open surface. The polishing pad 200 may include an upper pad 201 disposed at its upper portion and a lower pad 202 disposed under the upper pad 201.

FIG. 15 shows that the hole 210 is disposed in the upper pad 201. However, a depth to which the hole 210 is disposed is not limited as long as a surface of the hole 210 remains open through the surface of the polishing pad 200.

The hole 210 may be disposed only in the upper pad 201 of the polishing pad 200, as shown in FIG. 15, or may be disposed to span the lower pad 202. Alternatively, the hole 210 may span a portion of the platen 100 disposed under the polishing pad 200.

The acoustic sensor 400 may be disposed at different positions based on the depth of the hole 210.

The acoustic sensor 400 may be in contact with an inner bottom surface of the hole 210 if the depth of the hole 210 is greater than a height of the acoustic sensor 400. The acoustic sensor 400 may be embedded in the platen 100 if the hole 210 spans a portion of the platen 100.

In this example, an upper surface of the acoustic sensor 400 and an upper surface of the polishing pad 200 may have a height difference based on heights at which the acoustic sensor 400 and the polishing pad 200 are disposed. A cover 211 that blocks the open upper surface of the hole 210 may be further disposed on the top of the hole 210. However, it is not necessary that the cover 211 is disposed on the top of the hole.

When the cover 211 is disposed on the top of the hole, the cover 211 may function to protect the acoustic sensor 400 from an impact that may occur during the polishing process.

The cover 211 may be made of the same or similar material as the polishing pad 200.

In another embodiment, the cover 211 may be made of a different material from the polishing pad 200 and may be made of a material that does not include a porous structure. If the cover 211 does not include the porous structure, less signal attenuation may occur in a process of transmitting the acoustic emission generated in the polishing process to the acoustic sensor 400.

Alternatively, the cover 211 may be made of the same conductive polymer material as the first electrode 440 of the acoustic sensor 400. In this example, the cover 211 may be coupled to and disposed integrally with the first electrode 440 of the acoustic sensor.

In still another embodiment, an upper layer of the cover 211 may be made of the same material as the polishing pad 200 including the porous structure. The lower layer of the cover 211 may be made of the material that does not include the porous structure.

In addition, in another embodiment, the substrate polishing device 10 may further include a housing 220 disposed in the hole 210. The housing 220 may be sealed, and the acoustic sensor 400 may be disposed in the housing 220.

In this example, the acoustic signal generated from the substrate 1 may be transmitted to the acoustic sensor 400 by passing through a fluid filling the inside of the housing 220 through the upper surface of the housing 220 (e.g., air).

The housing 220 may function to fix the acoustic sensor 400 by surrounding an exterior of the acoustic sensor 400. In addition, the housing 220 may function to protect the acoustic sensor 400 from impact that may occur during the polishing process.

The housing 220 may have an open upper surface, in which case the cover 211 may be disposed thereon as shown in FIG. 15. However, the housing is not limited thereto.

In some embodiments, the upper surface of the housing 220 may be made of the same or similar material as the polishing pad 200. For example, the upper surface of the housing 220 may include a polyurethane resin and include the porous structure. The porous structure may be a structure including a large number of pores.

In another embodiment, the upper surface of the housing 220 may be made of a different material from the polishing pad 200 and may be made of the material that does not include the porous structure. If the upper surface of the housing 220 does not include the porous structure, less signal attenuation may occur in the process of transmitting the acoustic emission generated in the polishing process to the acoustic sensor 400.

Alternatively, the upper surface of the housing 220 may be made of the same conductive polymer material as the first electrode 440 of the acoustic sensor 400.

In still another embodiment, the upper surface of the housing 220 may have an upper layer made of the same material as the polishing pad 200 including the porous structure, and the lower layer made of the material that does not include the porous structure.

The upper surface of the housing 220 and the cover 211 may be opened or removed, and the acoustic sensor 400 may thus be easily disposed in the polishing pad 200.

The substrate polishing device 10 may further include a cable 500 connected to the acoustic sensor 400 and transmitting a signal to the outside. FIG. 15 simply shows that the cable 500 is connected to the acoustic sensor 400 disposed in the housing 220 in the hole 210.

The cable 500 may be connected to each of the first electrode 440 and the second electrode 450, which are included in the acoustic sensor 400, and the cable 500 connected to the acoustic sensor 400 may be connected to an external component by passing through the platen 100 (e.g., a receiver or power source).

FIG. 15 shows that the cable 500 connected to the acoustic sensor 400 is disposed vertically from the bottom of the hole 210 toward the bottom of the platen 100. However, a position where the cable 500 is disposed is not limited to that is shown in the drawing. The cable 500 connected to the acoustic sensor 400 is not limited to any specific position as long as the cable 500 is capable of being connected to the external component.

To polish a substrate, first, the platen 100 may be rotated based on a rotation of a rotation shaft 110.

The polishing pad 200 may be disposed on the upper surface of the platen 100 and rotated together with the platen 100.

The head 300 may be disposed above the polishing pad 200 and support the substrate 1 for the polishing surface 2 of the substrate 1 to face the polishing pad 200.

The head 300 may also be rotated based on a head axis 310 and, as the substrate 1 is rotated simultaneously as the head 300 is rotated, mechanical force may be applied between the polishing pad 200 and the substrate 1 to polish the polishing surface 2 of the substrate 1.

In the substrate polishing device 10 according to the present disclosure, the acoustic sensor 400 disposed in the polishing pad 200 may detect the acoustic emission transmitted from the substrate 1.

The polishing endpoint may be determined by using a change of an acoustic emission value based on the film quality of the substrate 1.

In an embodiment, the acoustic sensor 400 may include the first electrode 440, the second electrode 450 spaced apart from and facing the first electrode 440, the seed layer 460 made of the first piezoelectric material 422 and disposed on one of the inner surfaces of the first electrode 440 and the second electrode 450 facing each other, the plurality of nanorods each made of the first piezoelectric material 422 and extending from the seed layer 460 toward the first electrode 440 or the second electrode 450, and the coating 430 including the second piezoelectric material 424 and applied to at least a portion of each of the plurality of nanorods and the seed layer 460 (see FIGS. 1 to 4B).

In another embodiment, the acoustic sensor 400 may include the first electrode 440, the second electrode 450 spaced apart from and facing the first electrode 440, the first seed layer 462 disposed on the inner surface of the first electrode 440 among the inner surfaces of the first electrode 440 and the second electrode 450 facing each other, the second seed layer 464 disposed on the inner surface of the second electrode 450, and the plurality of nanorods 410 each extending from the first seed layer 462 toward the second seed layer 464.

Here, each nanorod 410 among the plurality of nanorods 410 may include the first nanorod portion 412 having one end in contact with the first seed layer 462 and the other end extending toward the second electrode 450, the second nanorod portion 414 having one end in contact with the other end of the first nanorod portion 412 and the other end in contact with the second seed layer 464, and the coating 430 disposed in the portion where the first nanorod portion 412 and the second nanorod portion 414 are in contact with each other. Each nanorod 410 may include the two or more types of piezoelectric materials 420 (see FIGS. 5 to 14B).

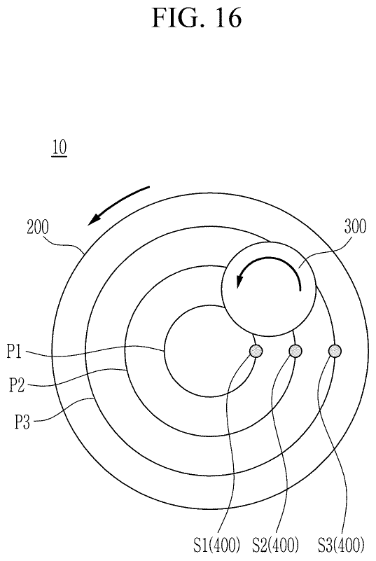

FIG. 16 is a view showing the substrate polishing device from the top according to an embodiment. This drawing shows a trajectory of the acoustic sensor 400 disposed in the polishing pad 200 based on the rotation of the polishing pad 200.

The plurality of acoustic sensors 400 may be disposed at different positions along a diameter of the polishing pad 200. Three or more acoustic sensors 400 may be disposed in the polishing pad 200.

Referring to FIG. 16, three acoustic sensors 400 may be disposed in the polishing pad 200, that is, on concentric circles S1, S2 and S3 having different diameters in the polishing pad 200.

The trajectory of the acoustic sensor 400 disposed on S1 may be indicated by P1, the trajectory of the acoustic sensor 400 disposed on S2 may be indicated by P2, and the trajectory of the acoustic sensor 400 disposed on S3 may be indicated by P3.

The plurality of acoustic sensors 400 disposed in the polishing pad 200 may all have the same shape.

In an embodiment, at least one of the plurality of acoustic sensors 400 may have a different arrangement of the piezoelectric material 420. The arrangement of the piezoelectric material 420 may refer to the shapes described above with reference to FIGS. 1 through 14B.

The different acoustic sensors 400 may be disposed at different positions on the polishing pad 200 to thus adjust the signal sensitivity based on its contact level with the substrate 1.

High and low sensitivity for describing the signal sensitivity may be relative, and the strength of the sensitivity may be adjusted by changing the arrangement of the piezoelectric material 420 in the acoustic sensor 400.

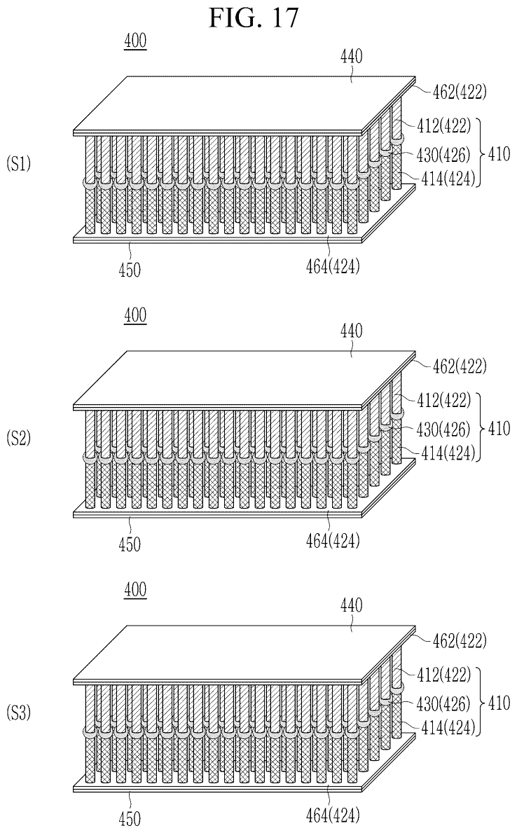

FIGS. 17 to 20 are views showing various embodiments of the acoustic sensor disposed in the substrate polishing device.

First, referring to FIG. 17, all the three acoustic sensors 400 disposed on S1, S2, and S3 may have the same shape. This shape may be the shape of the acoustic sensor 400 shown in FIGS. 4A and 4B, which corresponds to a high-sensitivity structure having the high sensitivity among the various shapes of the acoustic sensor 400 according to the present disclosure.

The high-sensitivity structure may be used for all the three acoustic sensors 400, thus maintaining the high sensitivity throughout the entire region.

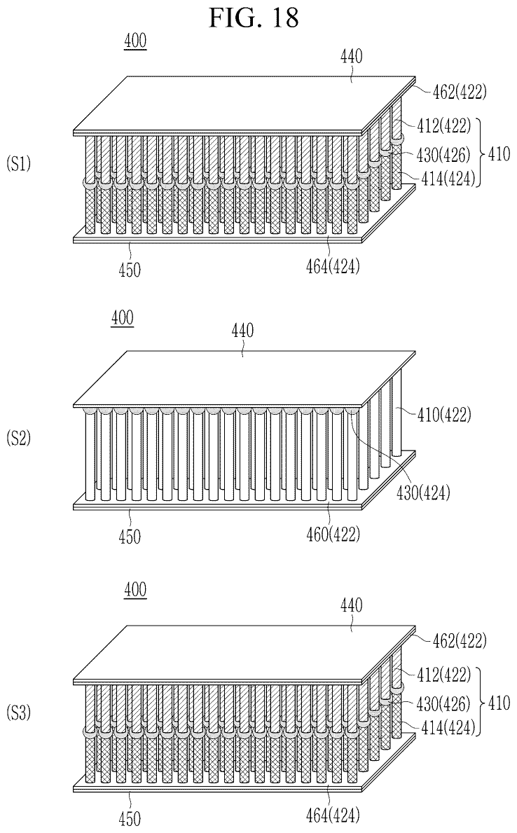

Referring to FIG. 18, the acoustic sensors 400 having the same high-sensitivity structure as in FIGS. 4A and 4B may be disposed on S1 and S3, and the acoustic sensor 400 having the same structure as that shown in FIG. 13A may be disposed on S2.

The acoustic sensor 400 disposed on S2 may have a trajectory passing through the center of the head 300 and having a relatively long signal collection time, while the acoustic sensors 400 disposed on S1 and S3 may have trajectories passing through an outer region of the head 300 and having a shorter signal collection time than the acoustic sensor 400 disposed on S2.

Accordingly, the high-sensitivity structure may be applied to the acoustic sensors 400 each disposed on S1 and S3 and having the shorter signal collection time, and a low-sensitivity structure may be applied to the acoustic sensor 400 disposed on S2 and having the relatively long signal collection time. The acoustic sensor 400 disposed on S2 may reduce cost despite having lower sensitivity.

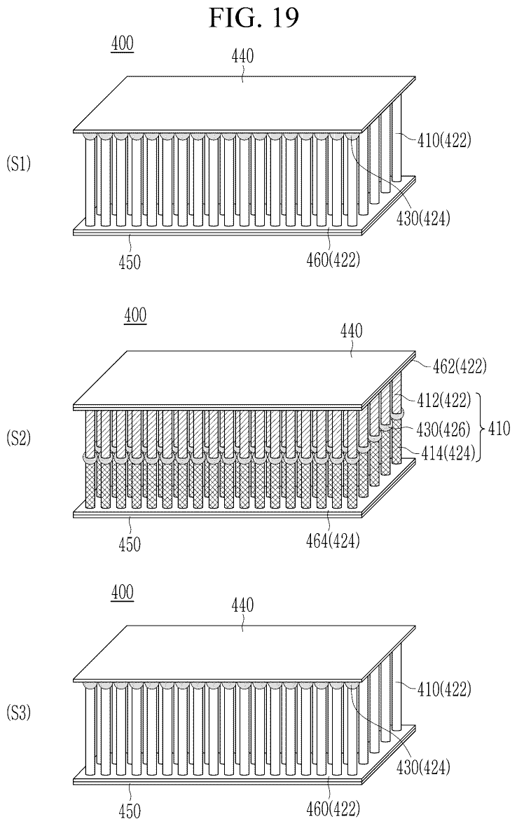

Referring to FIG. 19, the acoustic sensors 400 having the same high-sensitivity structure as in FIGS. 4A and 4B may be disposed on S2, and the acoustic sensors 400 having the same structure as that shown in FIG. 13A may be disposed on S1 and S3. In this embodiment, the acoustic sensors 400 may be disposed to be opposite to those shown in FIG. 18.

FIG. 19 shows that the acoustic sensor 400 having the high-sensitivity structure is disposed on S2, which has a wide contact area with the substrate 1, as its trajectory passes through the center of the head 300. The acoustic sensor 400 having the low-sensitivity structure may be disposed on each of S1 and S3, which has a relatively narrow contact area with the substrate 1.

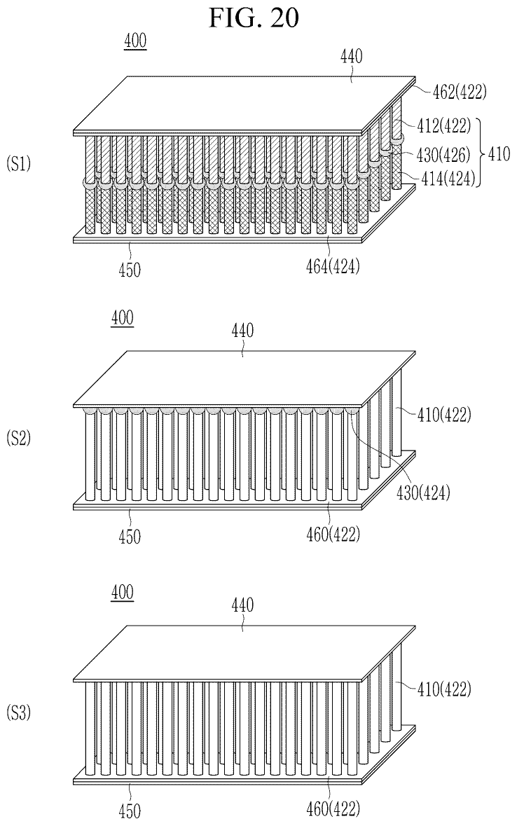

In FIG. 20, the acoustic sensors 400 having the same high-sensitivity structure as in FIGS. 4A and 4B may be disposed on S1, and the acoustic sensors 400 having the same structure as that shown in FIG. 13A may be disposed on S2. S2 may have lower sensitivity than S1.

The acoustic sensor 400 disposed on S3 may correspond to the acoustic sensor 400 that is generally used. In the acoustic sensor 400 disposed on S3, the plurality of nanorods 410 each including the first piezoelectric material 422 may be disposed between the first electrode 440 and the second electrode 450. The acoustic sensor 400 disposed on S3 may have lower sensitivity than the acoustic sensor 400 disposed on S2. That is, in FIG. 20, the acoustic sensor 400, whose sensitivity is decreased from S1 to S3, may be disposed.

FIGS. 17 to 20 show embodiments of the substrate polishing device 10 in which the different acoustic sensors 400 are each disposed at the positions along the diameter of the polishing pad 200.

However, the arrangement structure of the acoustic sensor 400 is not limited to the embodiments shown in FIGS. 17 to 20. As shown in FIGS. 1 through 14B, the various types of the acoustic sensors 400 may be disposed on the substrate polishing device 10 in various combinations.

In addition, FIG. 16 shows an example of the substrate polishing device 10, in which three acoustic sensors 400 are disposed in the substrate polishing device 10. The plurality of acoustic sensors 400, such as four or five acoustic sensors, may be disposed in the substrate polishing device 10.

in these examples, the plurality of acoustic sensors 400 may each be disposed at the positions along the diameter of the polishing pad 200. However, in some cases, the plurality of acoustic sensors 400 may be disposed on concentric circles having the same diameter.

Although the embodiments of the present disclosure have been described hereinabove, it should be understood that the inventive concept is not limited to the disclosed embodiments. Various modifications may be made within the scopes of the claims, the detailed description, and the accompanying drawings, which also fall within the scope of the present disclosure.

What is claimed is:

1. An acoustic sensor comprising:
a first electrode;
a second electrode spaced apart from and facing the first electrode;
a first seed layer disposed on an inner surface of the first electrode facing the second electrode;
a second seed layer disposed on an inner surface of the second electrode facing the first electrode; and
a plurality of nanorods disposed between the first seed layer and the second seed layer,
wherein each nanorod among the plurality of nanorods includes:
a first nanorod portion in contact with the first seed layer,
a second nanorod portion in contact with the second seed layer, and
a coating connecting the first nanorod portion and the second nanorod portion with each other, and
wherein each nanorod includes two or more types of piezoelectric materials.

2. The acoustic sensor of claim 1, wherein
each first nanorod portion and each second nanorod portion includes a first piezoelectric material, and
each coating includes a second piezoelectric material.

3. The acoustic sensor of claim 1, wherein
each first nanorod portion includes a first piezoelectric material,
each second nanorod portion includes a second piezoelectric material, and
each coating includes a third piezoelectric material.

4. The acoustic sensor of claim 1, wherein
a piezoelectric material included in the coating has a particle shape.

5. The acoustic sensor of claim 1, wherein
the first seed layer includes a piezoelectric material that is included in the first nanorod portion of each of the plurality of nanorods.

6. The acoustic sensor of claim 1, wherein
the second seed layer includes a piezoelectric material included in the second nanorod portion of each of the plurality of nanorods.

7. An acoustic sensor comprising:
a first electrode;
a second electrode spaced apart from and facing the first electrode;
a seed layer including a first piezoelectric material disposed on an inner surface of the first electrode facing the second electrode;
a plurality of nanorods, each including the first piezoelectric material and extending from the seed layer toward the second electrode; and
a coating on each of the plurality of nanorods, the coating including a second piezoelectric material and disposed on at least a portion of each of the plurality of nanorods and the seed layer.

8. The acoustic sensor of claim 7, wherein
each of the plurality of nanorods has a rod shape and has one end in contact with the seed layer and an opposite end in contact with the second electrode.

9. The acoustic sensor of claim 7, wherein the coating is a layer on a surface of the seed layer and an entire surface of each of the plurality of nanorods.

10. The acoustic sensor of claim 7, wherein the coating is a layer on at least a portion of each surface of the seed layer and each of the plurality of nanorods, including an end of each of the plurality of nanorods that is in contact with the seed layer.

11. The acoustic sensor of claim 7, wherein
the second piezoelectric material included in the coating has a particle shape, and
the coating is applied to such that the coating has a particle shape for each of the plurality of nanorods.

12. The acoustic sensor of claim 11, wherein the coating on each of plurality of nanorods is
applied to at least a portion of an exterior surface of each of the plurality of nanorods, including an end of each of the plurality of nanorods that is in contact with the seed layer.

13. The acoustic sensor of claim 11, wherein the coating is disposed
between a second end of each of the plurality of nanorods and the second electrode, wherein the second end of each of the plurality of nanorods is not in contact with the first electrode.

14. A substrate polishing device comprising:
a platen;
a polishing pad disposed on an upper surface of the platen and rotated together with the platen;
a head supporting a substrate for a polishing surface of the substrate to face the polishing pad; and
an acoustic sensor embedded in the polishing pad,
wherein the acoustic sensor includes
a plurality of nanorods, wherein each nanorod includes two or more types of piezoelectric materials.

15. The substrate polishing device of claim 14, wherein the acoustic sensor includes:
a first electrode,
a second electrode spaced apart from and facing the first electrode,
a seed layer made of a first piezoelectric material and disposed on an inner surface of the first electrode facing the second electrode,
a plurality of nanorods each including the first piezoelectric material and extending from the seed layer toward the second electrode, and
a coating including a second piezoelectric material disposed on at least a portion of each nanorod of the plurality of nanorods and the seed layer.

16. The substrate polishing device of claim 14, wherein the acoustic sensor includes
a first electrode,
a second electrode spaced apart from and facing the first electrode,
a first seed layer disposed on an inner surface of the first electrode facing the second electrode,
a second seed layer disposed on the inner surface of the second electrode facing the first electrode, and
a plurality of nanorods each extending between the first seed layer and the second seed layer,
wherein each nanorod among the plurality of nanorods includes:
a first nanorod portion having a first end in contact with the first seed layer and a first opposite end extending toward the second electrode,
a second nanorod portion having a second end in contact with the second seed layer and a second opposite end extending toward the first electrode, and
a coating connecting the first nanorod portion and the second nanorod portion with each other, and
wherein each nanorod includes the two or more types of piezoelectric materials.

17. The substrate polishing device of claim 14, wherein the acoustic sensor is one of a plurality of acoustic sensors that are disposed on concentric circles having different diameters in the polishing pad.

18. The substrate polishing device of claim 17, wherein the acoustic sensor is a first acoustic sensor of a plurality of acoustic sensors and the first acoustic sensor has a first arrangement of piezoelectric materials forming the first acoustic sensor that is different than a second arrangement of piezoelectric materials forming a second acoustic sensor of the plurality of acoustic sensors.

19. The substrate polishing device of claim 14, wherein
the polishing pad includes a hole in a surface of the polishing pad, and
the acoustic sensor is disposed in the hole.

20. The substrate polishing device of claim 19, further comprising
a housing disposed in the hole and accommodating the acoustic sensor,
wherein an upper surface of the housing is disposed on the same plane as an upper surface of the polishing pad.
